(19) United States
(12) Patent Application Publication
(10) Pub. No.: US 2016/0241348 A1
(43) Pub. Date: Aug. 18, 2016

(54) DETERMINING INFORMATION OF OBJECTS

(71) Applicant: NOKIA SOLUTIONS AND NETWORKS GMBH & CO. KG, Munich (DE)

(72) Inventors: Wolfgang ZIRWAS, Munich (DE); Berthold PANZNER, Holzkirchen (DE)

(21) Appl. No.: 15/027,638

(22) PCT Filed: Oct. 7, 2013
(86) PCT No.: PCT/EP2013/070760

§ 371 Date: Apr. 6, 2016

(51) Int. Cl. H04B 17/30; G01S 13/00

(52) U.S. Cl. CPC H04B 17/30; G01S 13/003

(57) ABSTRACT

Methods and apparatuses for providing information for use in determining a data map of objects are disclosed. Measurement information is provided by a receiver associated with a mobile communication system for objects in an area based on signals from transmitters with known positions. The measurement information is received at a central unit from the receiver and possibly also from at least one further receiver associated with the mobile communication system. A data map of objects in the area is then provided based at least in part on the received measurement information.

This disclosure relates to determining information of objects in association with a communication system.

A communication system can be seen as a facility that enables communications between two or more nodes such as fixed or mobile communication devices or terminals, access points such as base stations, servers, routers, machine type terminals, and so on. A communication system and compatible communicating entities typically operate in accordance with a standard which sets out how the system shall operate. For example, the standards and related specifications and related protocols can define how communicating nodes shall communicate, how various aspects of the communications shall be implemented and how the equipment shall be configured. In wireless communication systems signals can be carried on wireless carriers. Examples of wireless systems include public land mobile networks (PLMN) such as cellular networks, satellite based communication systems, different wireless local networks, for example wireless local area networks (WLAN), and various broadcasting systems.

Communications between various nodes, for example between a radio access system and a user device, is typically controlled by a controller in the system, for example by a control apparatus of a radio access network. Important control aspects are operation such as scheduling of data transmission to and from communication devices and channel estimation. Context aware techniques such as context aware scheduling, predictive scheduling and advanced channel prediction have also been proposed. These are considered particularly advantageous when applied in conjunction with transmission techniques like interference mitigation, joint transmission cooperative multipoint (JT CoMP) transmission, multiple input multiple output (MIMO), massive MIMO, network coding, full duplex and other such advanced techniques.

Techniques such as Wiener filtering can be used e.g. in channel prediction. However, Wiener filtering can have a limited prediction horizon. An approach aiming to address such limitations of Wiener filters is model based channel prediction (MBCP). Model based channel prediction can be based on a description or map of the environment where relevant transmissions take place. An example of such map is a building vector data map (BVDM) of the surrounding of a base station, and more particularly an enhanced NodeB (eNB) in accordance with third generation partnership project (3GPP) standards. However, model based channel prediction requires a very accurate and up to date map which may not be available or even achievable in all occasions. This may be the case in particular where moving objects such as for example people, animals, motor vehicles and so forth may be present in the relevant area. Although properties of static objects can be learned relatively accurately by long term observations this is not possible with moving objects. Nevertheless, moving objects can have a substantial effect on the channel conditions. Moving objects may significantly change channel conditions especially when they are close to antenna element(s). Because moving objects could have a substantial effect on the MBCP incorporation of information thereof into a dynamic BVDM or similar information would be desired.

Techniques such as channel prediction and/or context aware scheduling would thus benefit from information of moving objects. Knowledge of moving objects could include information of the location of such objects at a given time and direction and/or manner of movement of these objects. Improvement could be obtained, based on this information, for example by simply delaying transmission until the moving object has passed the relevant antenna element(s) and channel conditions are again unobstructed and/or by scheduling to devices that are not affected by the moving object(s).

Other applications, for example safety and various alerting applications could also benefit from more accurate information about objects in a particular environment, in particular from information about non-static objects.

However, so far it has been difficult, if not impossible, to easily and cost effectively obtain explicit enough information about objects in a particular area. Easily available information of moving objects might be desired.

It is noted that the above discussed issues are not limited to any particular communication environment, apparatus and applications but may apply to any appropriate system where information of objects is desired.

Embodiments of the invention aim to address one or several of the above issues.

In accordance with an aspect there is provided a method for determining information of objects, comprising receiving measurement information from at least one receiver associated with a mobile communication system configured to perform measurements of objects based on signals from transmitters with known positions, and providing a data map of objects in an area based at least in part on the received measurement information.

In accordance with an aspect there is provided a method for determining information for use in determining a data map of objects, comprising providing measurement information by a receiver associated with a mobile communication system for objects in an area based on signals from transmitters with known positions, and sending the measurement information to a central unit for use in determining a data map of objects in the area.

In accordance with an aspect there is provided an apparatus for providing information of objects in an area of a communication system, the apparatus comprising at least one processor, and at least one memory including computer program code, wherein the at least one memory and the computer program code are configured, with the at least one processor, to receive measurement information from at least one receiver associated with a mobile communication system, wherein the measurement information is based on signals from transmitters with known positions, and provide a data map of objects in an area based at least in part on the received measurement information.

In accordance with an aspect there is provided an apparatus for a communication network, the apparatus comprising at least one processor, and at least one memory including computer program code, wherein the at least one memory and the computer program code are configured, with the at least one processor, to cause providing of measurement information by a receiver associated with a mobile communication system for objects in an area based on signals from transmitters with known positions, and sending of the measurement information to a central unit for use in determining a data map of objects in the area.

In accordance with a more detailed aspect the measured signals are based on at least two different transmission standards. The signals can be transmitted on different frequency bands and/or different wavelengths and/or based on different mobile communication and/or broadcasting standards.

Measurement information can be provided in relation to moving objects. The information about moving objects can be processed to provide a dynamically updated data map of objects in the area.

The data map may define signal scattering and/or reflecting objects in the area.

The data map may be used for the purposes of at least one of predictive scheduling of data transmissions, channel prediction, a safety application, alarm application, traffic management, and crowd management.

Information of the data map may be communicated to at least one external entity configured to use the information.

The data map may comprise a building vector data map.

The data map may be provided with reliability information.

Measurement information for a number of measurements by different receivers on different signals may be combined.

At least one measurement may be provided by a base station, a relay node and/or a user device of the mobile communication system.

A station for a mobile communication system may be provided with apparatus for measuring at least two different signals.

A device for a communication system adapted to provide the herein described aspect can also be provided. According to an aspect the device comprises base station apparatus, a relay node or another network node and according to an aspect the device comprises mobile user equipment. A communication system embodying the apparatus and principles of the invention may also be provided.

A computer program comprising program code means adapted to perform the herein described methods may also be provided. In accordance with further embodiments apparatus and/or computer program product that can be embodied on a computer readable medium for providing at least one of the above methods is provided.

It should be appreciated that any feature of any aspect may be combined with any other feature of any other aspect.

Embodiments will now be described in further detail, by way of example only, with reference to the following examples and accompanying drawings, in which:

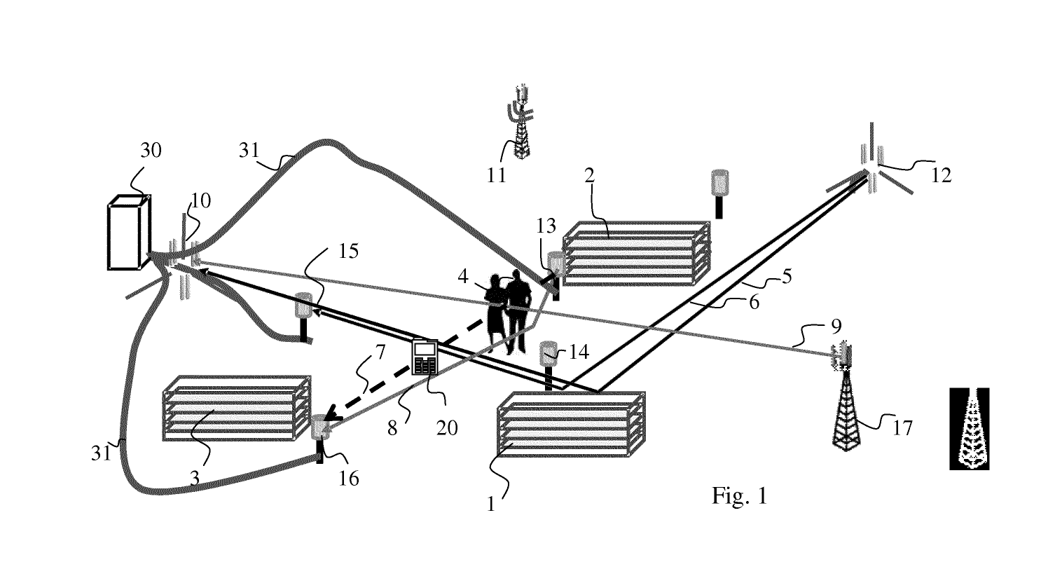

FIG. 1 shows a schematic diagram of a mobile communication system where certain embodiments can be implemented,

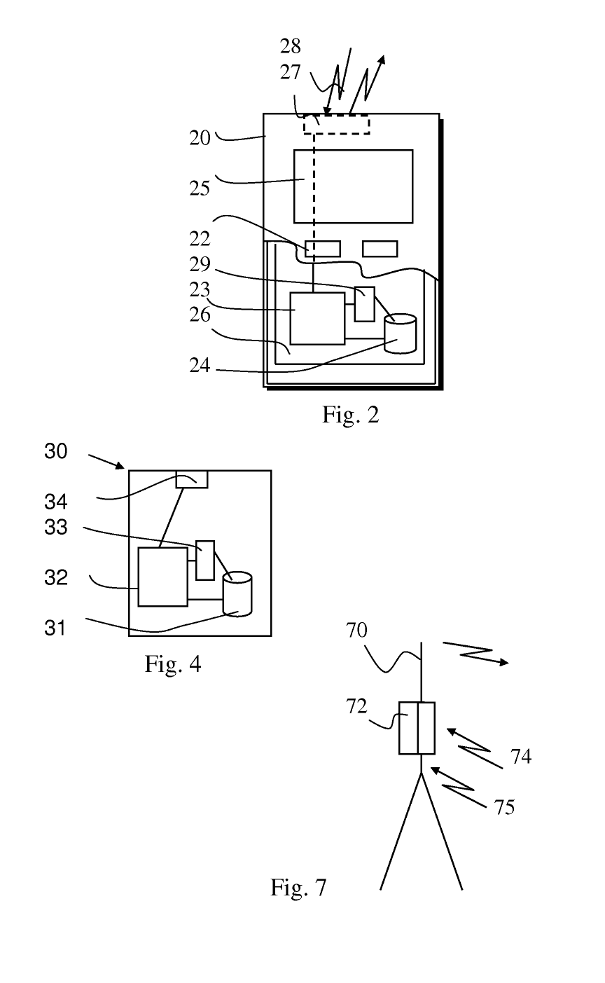

FIG. 2 shows an example of a communication device,

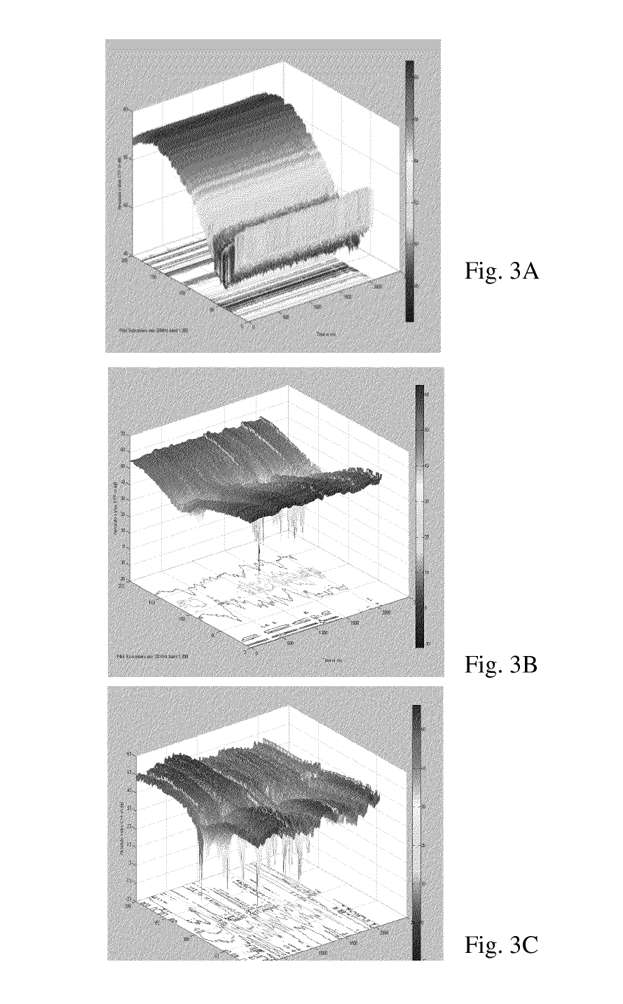

FIGS. 3A-3C show results for simulated channel transfer function over time for different number of moving objects in an area,

FIG. 4 shows an example of control apparatus,

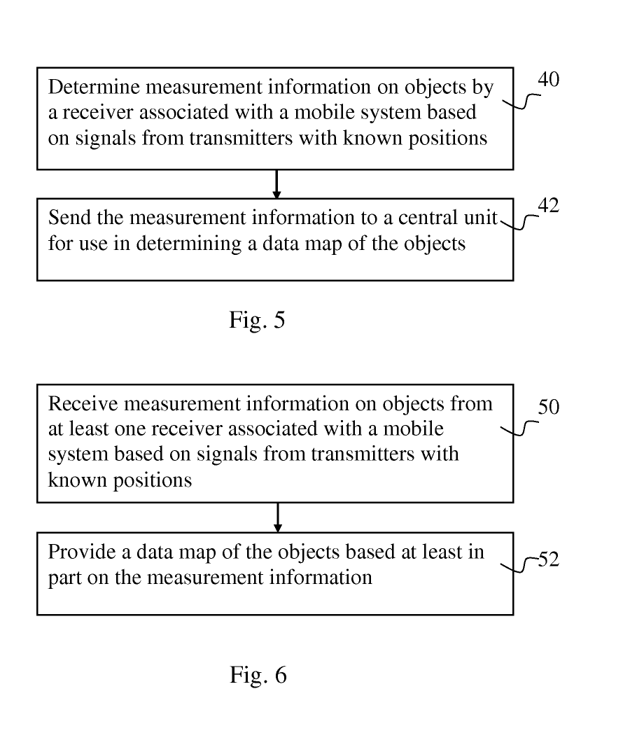

FIGS. 5 and 6 are flowcharts in accordance with certain embodiments, and

FIG. 7 shows an example for a station receiving and measuring signals from other stations.

In the following certain exemplifying embodiments are explained with reference to a wireless or mobile communication system serving mobile communication devices. Before explaining in detail the exemplifying embodiments, certain general principles of a wireless communication system and mobile communication devices are briefly explained with reference to FIGS. 1 to 3 to assist in understanding the technology underlying the described examples.

A non-limiting example of cellular communication system architectures is the long-term evolution (LTE) of the Universal Mobile Telecommunications System (UMTS) that is being standardized by the 3rd Generation Partnership Project (3GPP). The recent versions of the standard are often referred to as LTE Advanced (LTE-A). The LTE employs a mobile architecture known as the Evolved Universal Terrestrial Radio Access Network (E-UTRAN). Base stations of LTE and LTE-A systems are known as Node Bs or evolved or enhanced Node Bs (eNodeB; eNB), respectively, and may provide E-UTRAN features such as user plane Radio Link Control/Medium Access Control/Physical layer protocol (RLC/MAC/PHY) and control plane Radio Resource Control (RRC) protocol terminations towards communication devices. A base station such as eNodeB can provide coverage for an entire cell or similar radio service area. Other examples of radio access system include those provided by base stations of systems that are based on technologies such as wireless local area network (WLAN) and/or WiMax (Worldwide Interoperability for Microwave Access). WLANs are sometimes referred to by WiFi™, a trademark that is owned by the Wi-Fi Alliance, a trade association promoting Wireless LAN technology and certifying products conforming to certain standards of interoperability.

Communication devices or terminals 20 can be provided wireless access via base stations or similar wireless transmitter and/or receiver nodes. In FIG. 1 different radio stations 10-17 are shown. The radio stations can be base station, such as station for small cells or eNBs. It shall be appreciated that the number, size, shape and type of the base station and cells provided by them may vary considerably from those shown in FIG. 1. Base stations are typically controlled by at least one appropriate controller apparatus so as to enable operation thereof and management of mobile communication devices in communication with the base stations. The control apparatus can be interconnected with other control entities. The control apparatus can typically be provided with memory capacity and at least one data processor. The control apparatus and functions may be distributed between a plurality of control units. In some arrangements each base station can comprise a control apparatus. In alternative arrangements two or more base stations may share a control apparatus. In some embodiments the control apparatus may be respectively provided in each base station.

FIG. 2 shows a schematic, partially sectioned view of a communication device 20. A communication device of a user is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a portable computer such as a laptop or a tablet computer provided with a wireless interface card or other wireless interface facility, personal data assistant (PDA) provided with wireless communication capabilities, or any combinations of these or the like. A mobile device is typically provided with at least one data processing entity 23, for example a central processing unit and/or a core processor, at least one memory 24 and other possible components 29 for use in software and hardware aided execution of tasks it is designed to perform, including control of access to and communications with base stations and other communication devices. The data processing, storage and other relevant control apparatus can be provided on an appropriate circuit board and/or in chipsets. This feature is denoted by reference 26. Data processing and memory functions provided by the control apparatus of the mobile device to cause control and signalling operations in accordance with certain embodiments of the present invention will be described later in this description. The user may control the operation of the mobile device by means of a suitable user interface such as key pad 22, voice commands, touch sensitive screen or pad, combinations thereof or the like. A display 25, a speaker and a microphone are also typically provided. Furthermore, a mobile communication device may comprise appropriate connectors (either wired or wireless) to other devices and/or for connecting external accessories, for example hands-free equipment, thereto.

The mobile device may receive and transmit signals 28 by a base station or another communication device via appropriate apparatus for receiving and transmitting signals. In FIG. 2 the transceiver apparatus is designated schematically by block 27. The transceiver may be provided for example by means of a radio part and associated antenna arrangement. The antenna arrangement may be arranged internally or externally to the mobile device.

Space-division multiplexing may be provided by multiple antenna elements forming a phased array antenna. For example, a wireless communication device can be arranged for communication via a Multiple Input/Multiple Output (MIMO) or massive MIMO antenna elements. Other examples include single-input and multiple-output (SIMO) and multiple-input and single-output (MISO) multiplexing.

As shown in the example, fixed objects 1, and 3 and moving objects 4 can be located in the area such that they affect the manner signals from a transmitting station propagate. For example, signals paths 5 and 6 from station 12 are reflected by object 1 such that they are received by stations 10 and 15, respectively, from a different direction they would in line-of-sight conditions. Similarly, moving objects, in this example two people 4, obstruct temporarily the line-of-sight shown by the dashed line 7 between stations 13 and 16. The line-of sight to mobile device 20 is also obstructed by the people 4. At the same time the mobile receives the signals from station 12 reflected by object 1, for example a building. Thus paths 5 and 6 are unaffected multipath components (MPC) while MPCs 8 and 9 are blocked or diffracted by the moving persons.

Objects in an area can thus considerable affect radio conditions. The situation is made more difficult to control because at least some of the objects may be moving. This is illustrated by the graphs of FIGS. 3A to 3C showing example of evolution of channel transfer function (CTF) over time (2s) for different number of moving objects within an area for bandwidth of 20 MHz. More particularly, in FIG. 3A shows no persons move within an indoor room. FIG. 3B shows the same room with one moving person. FIG. 3C illustrates a situation where four persons are moving randomly in the room. As can be seen, the pattern is different dependent on whether there are moving objects and also on the amount of objects moving in the area. The below described schemes for providing a data map taking the object into account aim to address this.

FIG. 1 shows further a data processing apparatus 30 connected to radio stations 13, 15 and 16 of the mobile communication system and providing an aspect of an overall setup for sensing and tracking moving and other objects. The radio stations are configured to perform channel estimation based on available signals from different radio standards transmitting on different carrier frequencies and to send this information over a backhaul 31 to the central processing unit 30 for evaluation. Transfer of channel information and other information from the different receiver stations or cells to the central processing unit can be provided e.g. via standardized ×2 messages. The central processing unit 30 maintains a BVDM of the surrounding area as well as about the exact position of the known radio stations.

FIG. 4 shows an example of a control apparatus 30, for example to be integrated with, coupled to and/or otherwise arranged in association with a mobile communication system. The control apparatus 30 can be arranged to receive and analyse information from measuring stations and to provide control on communications in the area. The control apparatus 30 can be configured to provide control functions in association with scheduling, channel prediction and so on in one or more cells in accordance with certain embodiments described below. For this purpose the control apparatus comprises at least one memory 31, at least one data processing unit 32, 33 and an input/output interface 34. Via the interface the control apparatus can be coupled to a receiver and a transmitter of at least one base station. The control apparatus can be configured to execute an appropriate software code to provide the control functions. It shall be appreciated that similar component can be provided in a control apparatus provided elsewhere in the system.

Example will now be described where more accurate information about objects in an area of a radio system is provided. The herein described examples provide a distributed invisible remote sensing system based on a concept called ‘passive radar’ for defining objects in data map system such as a BVDM.

Radars, or more generally identification and remote sensing of objects have conventionally used dedicated transmitters and receivers for the location operations. Conventional radar systems comprise a collocated transmitter and receiver where the range of an object is determined based on a transmitted signal and the time taken for the signal to travel to the object and back. In passive radar there is no dedicated transmitter. Passive radars allow for an unperceived surveillance utilizing other illuminating sources whose initial indented objective can be a different application, e.g. analogue frequency modulation (FM) broadcasting, terrestrial digital video broadcasting (DVB-T) and digital audio broadcasting (DAB) transmitters. A passive radar receiver can use third-party transmitters and measure the time difference of arrival between the signal arriving directly from the transmitter and the signal arriving via reflection from the object. Thus a bistatic range of the object can be determined. In addition to bistatic range, a passive radar can also measure the bistatic Doppler shift of the echo and also its direction of arrival. These allow the location, heading and speed of the object to be calculated. In accordance with the herein discussed principles multiple transmitters and/or receivers can be employed to make several independent measurements and hence significantly improve the final track accuracy. However, the known passive radars utilize a narrow bandwidth in the kHz range and the limited channel bandwidth results in poor range resolution and thus range bins of several hundreds of meters.

In accordance with an example in the current invention a passive radar system is used in association with a mobile communication system where signals from a mobile system can be used as an illumination source. The receiver of the radar can also be associated with a mobile network. Passive radar applications used in association with a mobile system can also utilise on broadcast standards like the analogue frequency modulation (FM) radio stations, terrestrial digital video broadcasting (DVB-T) and digital audio broadcasting (DAB) transmitters, as these are typically provided with very high transmit power from known and usually exposed transmitter locations. Although not limited by these, the concept can be particularly advantageously applied in respect to advanced wireless systems such as LTE, LTE-A and fifth generation (5G) mobile broadband communication systems.

Measurement information from all distributed receiver stations in a certain area can be collected and transferred over a backhaul to a predefined central node for evaluation. The central node can be configured to provide a constantly updated BVDM of the surroundings and a set of estimated moving objects within the BVDM. The evaluation can be based for example on an adapted and enhanced version of conventional radar algorithms.

FIG. 5 illustrates operation in a radio station configured to measure location relevant information based on signals from other stations. In accordance with the shown method for determining information for use in determining a data map of objects in an area location measurement information is provided at 40 by a receiver associated with a mobile communication system for objects based on signals from transmitters with known positions and provided by a different station than the receiver. The location measurement information is communicated at 42 to a central unit for processing to provide a data map of objects in an area.

FIG. 6 illustrates the operation in the central unit receiving information from one or more receivers. At 50 location measurement information is received from at least one receiver associated with a mobile communication system configured to perform measurements of objects based on signals from transmitters with known positions. The received measurement information is processed at 52 to provide a data map of objects in an area.

Information from one receiver can be processed together with location measurement information from at least one another receiver to improve efficiency and/or accuracy of the determination. The receivers may be configure to measure different signals, e.g. signals from different communication and/or broadcasting networks and/or on different frequencies or bandwidths.

Transmitters of signals to be measured by a receiver can be provided by different radio stations than where the receiver is placed.

Electromagnetic waves transmitted by different radio stations like eNBs, DVB-T transmitters and so on are backscattered and reflected by stationary and moving objects. The distributed invisible radar system senses these backscattered and reflected signals and creates or updates a dynamic model of the physical surrounding. Thus an imaging system can be provided that models the environment and its surroundings into a dynamic virtual map providing up-to-date information about scattering objects in the relevant space and geometry based channel prediction can be provided. A map such as the BVDM can be created that can be used to estimate the wireless radio channel. Use of the mobile system in the passive radar provides localisation capabilities of the surroundings and also capability to dynamically locate moving objects, thereby improving advanced channel prediction as well as context aware schemes based on geometry data. Blind monitoring of stationary and moving objects within e.g. a LTE network can be provided for creation of an accurate and constantly adapted BVDM.

Remote sensing of objects as well as tracking of moving objects can be provided utilizing simultaneously different existing sources of radio transmissions. For example, the sensing can be based on signals by more than one of the established mobile radio networks such as the GSM, WCDMA, and LTE and in future from the fifth generation (5G) based systems as well as for example DVB-T, DAB, and so on.

FIG. 1 shows a number of available fixed radio stations with known positions. The stations can be equipped with appropriate dedicated receivers for a multiple of radio standards. This is shown in FIG. 7 where a radio station 70 is provided with receiver apparatus 72 configured to receive two different signals 74 and 75 from transmitters of different signals.

The reporting stations can comprise for example eNBs and/or small cells such as pico cells and/or relay node stations. This allows estimation of radio channels from the respective transmitters to the receiver sites as accurately as possible in different frequency bands. Combining of information obtainable via different radio frequency (RF) carriers and different radio systems enables sensing over a wide range of frequency bands with a wide variation of wavelengths. This allows an efficient but robust analysis as the large wavelengths allow identification of object position with high probability with only minor ambiguities. At the same time the accuracy can be high based on the measurements for the high RF frequencies. Measuring the same object by many different Tx-Rx links helps to minimize location estimation errors further. Thus signals from several base and/or other radio stations illuminating a common area can be combined to fusion a virtual map with very high resolution.

The sensing and tracking is possible without transmitting any extra new reference signals to those used by the established systems. For example, the primary and secondary synchronization signals of the LTE as well as the cell-specific reference signals in the downlink can be used as excitation signals. These signals are already specified in 3GPP standard and any variation of these signals can be determined as being caused by the surrounding/moving objects and the central control unit can draw conclusions on the environment based on this information.

The sensing can be provided solely based on system specific standardised reference signals. As these are typically different for different communication standards the receivers can be adapted to separate the different standards and signals. Signals which are already on air can thus be reused. Specific receivers can be added to the cellular systems for measuring certain radio systems like DAB, DVB-T etc. Thus there is no impact on the legacy systems, e.g. there is not necessarily any need to standardize any specific measurement phases for e.g. LTE or DVB-T signals. There is no need for additional resources and additional power either. Also, the tracking can be done constantly as e.g. references and/or synchronisation signals are available anyway.

A mobile communication system can comprise one or more mobile networks. For example, a single radio access network (RAN) based solution including GSM, WCDMA, LTE, 5G and so on may provide in certain applications most of the required measurement information. Information form more than one network may be combined. The efficiency of an arrangement relying on signals by mobile communication network(s) can be improved by organizing suitable measurement phases and by collecting all available information into a central server. At the central server advanced algorithms can be implemented to extract useful information and to feed it back to interested base station apparatus, e.g. eNBs and small cells in the area so that they can add this information about moving objects into their BVDMs or context aware scheduler maps.

The range resolution of a reconstructed image of an environment is related to the bandwidth of the excitation signal. This can be given e.g. by the classic Rayleigh resolution. 3GPP LTE Release 12 and onwards takes advantage of carrier aggregation with up to five component carriers (CC) a passive radar can benefit from accurate range resolution, even if this is limited to LTE only sensing. With expected future bandwidth enlargement for 5G into the GHz domain a range in a few, or even one centimetre is anticipated.

Where frequency division duplex (FDD) is used eNBs transmit in downlink (DL) on one frequency band and listen on uplink (UL) on another frequency band. Therefore eNBs cannot listen to reference signals of other eNBs. To address this particular issue of frequency division duplex (FDD) the eNBs can stop transmission on the downlink (DL) frequency band during measurement phase and listen to the reference signals of other eNBs. Another possible solution is to use a fixed test UE for measuring. For that purpose an UE can be placed close to an eNB so that the UE can listen to other eNBs. An option is to include the UE functionality into an eNB so that the eNB can switch into UE mode during certain measurement phases. This means the eNB receives on the DL frequency band instead on the UL. Time division duplex (TDD) mode and OFDM in UL and DL are simpler in this regard.

Radio stations with low and high RF carrier frequency may be located at different and potentially far off positions. In such cases the evaluation may not directly lead to a single broadband channel impulse response (CIR) but a set of different CIRs with different main wavelengths and frequency bands. This may require a more advanced signal processing, but nevertheless can benefit from the large variation of wavelengths.

A possible processing scheme to evaluate the channel variations caused by moving objects is to perform the analysis from one time slot to the next time slot. Variations of single multipath component (MPCs) for each CIR may be identified.

Tracking of moving objects can be based on comparison of information obtained by subsequent measurements.

Interferometric techniques can be used to sense a long term change in a certain scenery by comparing the virtual BVDM between large time-spaced samples. That might help to interpret for instance the level of foliage in a distinct area.

Time stamps for measurements like frame number in case of a synchronized network can be added to the reporting.

The backhaul overhead is not expected to be excessive as the reporting may contain only estimates for the CSI reference signals (RSs) or even a more condensed form of the channel information.

After some time of operation the tracking accuracy can be expected to increase from that of the starting the operation. This is so since in a typical environment moving objects cannot move on random trajectories, thus allowing for some interpolation gain.

The resolution in space can be determined to a large extent by the effective measurement bandwidth defined by the difference between lowest and highest RF frequencies of the used radio systems. For example including DAB and 5G this might span an overall bandwidth (BW) of several GHz, even if interspaced with certain bandwidth gaps without any CSI knowledge. The inter tap spacing of a combined channel impulse response (CIR) can be in an order of Δτ=1/BW of <0.1 to 1 ns, which in turn allows for a space resolution of few centimetres.

So called mmWave systems are being envisaged for 5G systems. These can be especially helpful for the sensing due to their low wavelength and/or the extreme overall bandwidth which is possible by combining the results from the low megahertz up to tens of GHz. Furthermore mmWave is expected to support efficient and narrow beamforming which allows discrimination and sensing of objects geometrically with high angular accuracy.

In case of mmWave—or more generally of massive MIMO systems—extensive beamforming gains can be utilised to steer very narrow beams from all radio stations in a coordinated manner during the measurement phase. With decreasing beamwidth a more and more angular accurate positioning of objects is possible.

Specific measurement phases where e.g. eNBs transmit reference signals with higher orthogonality and/or higher power and with less inter cell interference may be provided. This can enable an accurate CSI estimation for even more far off eNBs. Tracking of objects by measurements in the range of once every second is believed to be sufficient, and therefore measurement overhead can be kept relatively low.

Tracking in different frequency bands can also be used for the purposes of obtaining more information about the moving objects, by analysing transmission, diffraction and reflection behaviour. For example, information may be processed to be able to distinguish between persons and/or object types such as if the object is a tree, car, brick wall and so on. Polarimetric illumination using several frequency bands can be used to get more information about material related parameters of the objects. This can allow distinguishing between different material parameters and surface properties of the observed objects. For example, whether the object are of permeable, solid, reflective, absorbing, diffusing and so on material and if the object is a living creature (person, animal), a tree, car, building, and so on.

In accordance with an embodiment the information about moving objects is broadcast to the user devices. This can be helpful for MBCP in application where the user devices require an accurate BVDM including knowledge about moving objects.

As mentioned above radio stations such as eNBs and small cells can be used since they are located at fixed and known locations. In accordance with a possibility mobile devices, for example UEs, may also be used for sensing information of stationary and/or moving objects. This has the benefit that there are typically more UEs than radio cells in an area and thus more accurate sensing may be provided. Accurate information of the location and movements of the UEs is needed but in case techniques such as MBCP are used this information is needed anyway. For example, UEs report typically CSI information for the frequency band of their serving cell. When providing the sensing information the UEs can report additional CSI information for additional radio stations, additional frequency bands, additional carrier frequencies of a plurality of radio standards and so on.

The herein described sensing and tracking can be combined with established location estimation methods for mobile UEs as a moving UE will be typically carried by a person or will be within a moving vehicle such as a car, bus or train.

In case of MIMO and massive MIMO the UEs might do beam specific reporting. This is to address the possibility of different beams scattering differently and/or propagating on different paths. Use of massive MIMO can be beneficial as this decreases the beamwidth and increases location accuracy.

In case an object has been already identified the reporting can be limited to some relevant beams allowing for an accurate sensing of further movements of the object. But generally due to the relative seldom measurement phases the overall reporting overhead is expected to be low (<kbit/s).

Due to the dense deployment of modern mobile communication networks, in particular the LTE based networks, in urban and rural areas the invention is applicable wherever network coverage is available. The invention allows for a permanent surveillance of the environment.

The objects to be observed are unaware of the monitoring due to the passive illumination of the objects by the existing (ubiquitous deployed) radio systems. For privacy reasons the evaluation algorithm in the central unit may be provided only with location information and possibly e.g. the information of the device type, while the UE ID and any other personal information is kept confidential.

In addition to use of the determined position information for the purposes of control of wireless communications the information can be used for other applications as well. An example of possible use scenarios is in the context of motor vehicles, for example for safety and traffic management applications. For examples, cyclists, pedestrians, animals or other moving objects that might suddenly move onto a road in front of a car or object moving towards rail tracks when a train is approaching can be detected based on the information. Appropriate action such as an alert and/or automatic breaking may then be taken in response to the information. The herein disclosed solution can be advantageous even in case where the vehicle is equipped with an onboard radar, ultrasonic sounders or cameras when the direct view to e.g. a pedestrian is blocked by an obstacle and therefore neither an on-board RADAR, ultrasonic sounders nor cameras will be able to detect such pedestrians and a pre-warning message to the car driver is impossible. Another example is an event organiser who may wish to understand where the mass of people is moving and if there are critical accumulations of people in some areas and so on and use the information for crowd management. In accordance with a possible use scenario a mobile operator determines an accurate picture of objects (stationary and moving) in an area. The operator can provide this information to other interested parties as a service. For example, the operator can provide car manufacturers and/or event organisers with such information. An operator may provide the determined information also to other operators in an area. For the purposes of ease of distribution of the information a protocol how to exchange information about moving objects may need to be defined/standardized.

The determined position information may be provided with reliability information. For example, it can be indicated that location of user k has a standard deviation of x cm, or velocity is accurate to x % and so on.

Various advantages may be provided. Combination of different mobile radio communication and possibly broadcasting standards as host illuminator provides increased resolution due to the much higher bandwidth and range of wavelengths covered by the different systems. The combination of many distributed Rx- and Tx-sites allows for a high resolution of the locations of the moving objects, as the objects are being sensed from many different directions.

Also, context awareness is becoming more and more important in the future systems. For example, content caching solutions at the eNB have been proposed. Combining these with the above described aspects is believed to provide an efficient content delivery system.

It is noted that whilst embodiments have been described in relation to elements and terminology of LTE and certain releases thereof, similar principles can be applied to any other communication system or further developments with LTE. Also, instead of transmission of the monitored signals by fixed base stations transmissions may be provided by a non-stationary device such as a mobile station. For example, this may be the case in application where no fixed equipment provided but a communication system is provided by means of a plurality of user equipment, for example in adhoc networks or other mobile stations that can act as a base or relay station. It shall also be understood that various different means can be provided to implement the herein described principles, and that the herein described examples are not intended to limit the means suitable for implementing the invention. Therefore, although certain embodiments were described above by way of example with reference to certain exemplifying architectures for wireless networks, technologies and standards, embodiments may be applied to any other suitable forms of communication systems than those illustrated and described herein.

The required data processing apparatus and functions may be provided by means of one or more data processor circuits and/or processor cores. The described functions may be provided by separate processor ciscuits or by an integrated processor circuit. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the spirit and scope of this invention as defined in the appended claims. Indeed there is a further embodiment comprising a combination of one or more of any of the other embodiments previously discussed.

1. A method for determining information of objects, comprising:
receiving measurement information from at least one receiver associated with a mobile communication system configured to perform measurements of objects based on signals from transmitters with known positions, and
providing a data map of objects in an area based at least in part on the received measurement information.

2. A method for determining information for use in determining a data map of objects, comprising:
providing measurement information by a receiver associated with a mobile communication system for objects in an area based on signals from transmitters with known positions, and
sending the measurement information to a central unit for use in determining a data map of objects in the area.

3. A method according to claim 1, wherein signals transmitted based on at least two different transmission standards are measured.

4. A method according to claim 1, wherein at least one of the following are measured:
signals transmitted on different frequency bands,
signals transmitted on different wavelengths,
signals based on different mobile communication standards, and
signals based on different broadcasting standards are measured.

5. A method according to claim 1, comprising providing measurement information in relation to moving objects and processing the information about moving objects to provide a dynamically updated data map of objects in the area.

6. A method according to claim 1, wherein the data map defines signal scattering and/or reflecting objects in the area.

7. A method according to claim 2, comprising using the data map for the purposes of at least one of predictive scheduling of data transmissions, channel prediction, a safety application, alarm application, traffic management, and crowd management.

8. A method according to claim 2, comprising communicating information of the data map to at least one external entity configured to use the information.

9. A method according to claim 2, wherein the data map comprises a building vector data map.

10. A method according to claim 2, comprising providing the data map with reliability information.

11. A method according to claim 2, wherein at least one measurement is provided by a base station, a relay node and/or a user device of the mobile communication system.

12. An apparatus for providing information of objects in an area of a communication system, the apparatus comprising at least one processor, and at least one memory including computer program code, wherein the at least one memory and the computer program code are configured, with the at least one processor, to cause the apparatus to:
receive measurement information from at least one receiver associated with a mobile communication system, wherein the measurement information is based on signals from transmitters with known positions, and
provide a data map of objects in an area based at least in part on the received measurement information.

13. An apparatus for a communication network, the apparatus comprising at least one processor, and at least one memory including computer program code, wherein the at least one memory and the computer program code are configured, with the at least one processor, to cause the apparatus to:
provide measurement information by a receiver associated with a mobile communication system for objects in an area based on signals from transmitters with known positions, and
send the measurement information to a central unit for use in determining a data map of objects in the area.

14. An apparatus according to claim 13, configured to process measurement information of signals based on at least one of the following:
two different transmission standards; signals transmitted on different frequency bands, and/or
signals transmitted on different wavelengths,
signals transmitted based on different mobile communication standards, and
signals transmitted based on at least one broadcasting standard.

15. An apparatus according to claim 13, wherein the objects comprise moving objects, the apparatus being configured to process information about moving objects to provide a dynamically updated data map of objects in the area.

16. An apparatus according to claim 13, wherein the data map is provided for the purposes of at least one of predictive scheduling of data transmissions, channel prediction, a safety application, alarm application, traffic management, and crowd management.

17. A device for a communication system comprising the apparatus of claim 12.

18. A station for a mobile communication system comprising the apparatus according to claim 13, comprising at least two receivers configured to measure at least two different signals.

19. A data processing entity connected to a mobile communication system comprising the apparatus according to claim 18, configured to combine measurement information from a plurality of stations.

20. (canceled)
